(19) United States
(12) Patent Application Publication
(10) Pub. No.: US 2023/0127236 A1
(43) Pub. Date: Apr. 27, 2023

(54) Wheel System, Kit and Method

(71) Applicant: Bannack Medical LLC, Gilbert, AZ (US)

(72) Inventors: Arlen Olsen, Clifton Park, NY (US); Joel Price, Germantown, MD (US)

(21) Appl. No.: 17/510,864

(22) Filed: Oct. 26, 2021

Related U.S. Application Data
(63) Continuation-in-part of application No. 17/510,787, filed on Oct. 26, 2021.

(51) Int. Cl. A47H 13/00; A47H 1/06; A47H 15/04

(52) U.S. Cl. CPC A47H 13/00; A47H 1/06; A47H 15/04; A47H 23/10

(57) ABSTRACT

Disclosed is a wheel system and a kit and method, for use with a track, said wheel system comprising: a wheel carriage; a set of wheels, attached to the wheel carriage; —a link, having a first end, releasably attached to the wheel carriage and a second end releasably attached to an extension. Also, disclosed is a wheel system, for use with a track, the wheel system having a wheel carriage; a set of wheels, attached to the wheel carriage; —a link, having a first end, operatively attached to the wheel carriage; wherein angles of the wheels and the width of the wheel carriage are sized to fit into multiple sizes of tracks.

### CROSS-REFERENCE TO RELATED APPLICATIONS

This application is a continuation-in-part of U.S. application Ser. No. 17/510,787 filed on Oct. 26, 2021, and is related to U.S. application Ser. No. 17/225,321 filed on Apr. 8, 2021; U.S. application Ser. No. 17/011,571 filed on Sep. 3, 2020; U.S. application Ser. No. 17/004,625 filed on Aug. 27, 2020; and U.S. application Ser. No. 16/933,545 filed on Jul. 20, 2020 which all disclosures are hereby incorporated by reference in their entireties.

### FIELD OF THE INVENTION

Disclosed is a wheel system, kit and method. In particular, is a wheel system having preassembled wheels and kit most often for use with an extension or quick connect for curtains, and most often, for use in health care facilities to maintain a clean environment.

### BACKGROUND

Health care facilities, such as hospitals, nursing homes, doctor's offices, urgent care facilities, and long-term care facilities are becoming more and more concerned with infectious diseases being present. The COVID-19 pandemic is one major infectious disease that has brought attention to the public by the media to the concerns of cleanliness of health care facilities and other public spaces. In addition to COVID-19 are other infections diseases such as bacterial infection diseases like Anthrax, bacterial botulism, brucellosis, cholera, diphtheria, Lyme's disease, tuberculosis; fungal infectious diseases like aspergillosis, blastomycosis, candidiasis, cryptococcosis, histoplasmosis; parasitic infectious diseases like ascariasis, cryptosporidiosis, giardiasis, malaria, scabies; prion infectious diseases like Alper's syndrome, Creutzfeldt-Jakob disease, kuru; and viral infectious diseases like COVID-19, AIDS, chickenpox, Common Cold, Ebola, herpes, Influenza, mumps, rabies, rubella, viral meningitis, yellow fever and many more.

One location in the hospital that has a concern with infectious disease are the privacy curtains in locations such as the Emergency Room (“ER”) and Intensive Care Unit (“ICU”). Medical personnel will take many precautions such as washing hands, wearing gloves and wearing personal protection equipment. However, while wearing gloves they will grab the curtains with their gloved hands which may leave infectious diseases on the curtains due to contact with bodily fluids such as blood, saliva, urine, mucous, phlegm, etc. In addition, patients which are surrounded by the curtain systems will cough, sneeze or perform other bodily functions which expel airborne liquids into the air surrounding their bed or private space.

Curtain systems for hospitals are generally attached to the ceiling. The curtains systems have a track which is affixed to the ceiling. Within the track are rollers, guides or wheels.

A difficulty with this system is that the tracks and hooks are attached to ceilings that can be from 7 to 12 feet above the floor. This requires maintenance personnel at the hospital to use ladders or other stools to replace the curtains.

A further difficulty is when replacing the curtain system, the wheels, guides or rollers have hooks which many times need to be crimped causing repetitive problems with the installer having problems with muscles and tendons due to repetitive installation of the curtains on the hooks.

Another difficulty is that the most curtain systems are not easily and quickly disassembled and require personnel to remove the curtains, one hook at a time.

Another difficulty is that the track generally is sold separately or are already existing and thus when installing the elongate member or extension and quick release requires extensive work that needs to be done to attach the system in-situ while the installer is on a ladder.

Another difficulty is that the tracks come in multiple sizes. The individual installing or replacing of the wheel systems needs to be selected from multiple sizes of wheels to fit the appropriate track.

Another difficulty is that hooks and metal loops don't allow for quick attachment systems to be quickly aligned due to difficulty of rotation and alignment and are susceptible to binding with one another.

### SUMMARY

Disclosed is a wheel system, kit and method for a disposable curtain system or other hanging slidable devices. An advantage is the ability to quickly attach a disposable curtain system to a pre-existing or installed curtain system.

Another advantage is the ability to quickly attach a disposable curtain system to a pre-existing or installed track.

Another advantage is during installation, there will be no or minimal need for health care personnel to climb on ladders or stools to reach the hooks for replacement of the curtains.

Another advantage is that health care personnel will not need to crimp the hooks used on pre-existing wheel systems.

Another advantage is removal and disposal and or recycling of the curtains on a regular basis.

Another advantage is that the quick release and lock system may be usable by an installer/disassembler at approximately a height of 6-7 feet for easy installation and removal, it will have disposable curtain attachments that quickly attach and detach with a single or small number or movements during installation and disassembly.

Another advantage is the current system makes it possible to remove the end from a track and install the wheel system with the elongate member or extension and quick-release all at once. In the case of replacement, the old rollers or wheels merely need to be removed.

Another advantage is that with a link, releasably attached to an end cap, the length of the elongate member or extension may be easily changed.

Another advantage is that an end cap may rotate so that it need not align with the direction of the quick-release connectors because the connection between the link and the end cap may swivel or rotate.

Another advantage is that wheel system may rotate so that it need not align with the direction of the quick-release connectors because the connection between the link and the wheel system may swivel or rotate.

Another advantage is that the link is releasably attached at the wheel system and at the end cap so that either the wheel system or the extension or quick release may be quickly detached and replaced.

Another advantage is that the wheel system is dimensioned for multiple tracks thus reducing the number of wheel systems and installer must carry to fit into various tracks.

Another advantage is having a wheel system that will easily glide along the track and not bind up with hooks from nearby wheel systems.

Another advantage is that a kit with multiple wheel sizes, carriage sizes, wheel angles may be provided so that an installer may easily install the wheels without the need for finding the proper fit for the track. Another advantage is that the wheel systems may be easily interchanged based upon the size of the track.

Accordingly, various embodiments of the invention disclosed include: Accordingly, provided is a wheel system, for use with a track, said wheel system comprising: a wheel carriage; a set of wheels, attached to the wheel carriage; a link, having a first end, releasably attached to the wheel carriage and a second end releasably attached to an extension.

Accordingly, further embodiments of the invention provide a kit, wherein the kit includes a wheel system comprising at least two sets of wheel systems. The wheel systems have wheels with axes at different angles with respect to each other. The wheel systems have wheels of different sizes. The wheel systems are interchangeable. The wheel systems have different sized wheel carriages.

Accordingly, various embodiments of the invention disclosed include: A wheel system, for use with a track, said wheel system comprising: a wheel carriage; a set of wheels, attached to the wheel carriage; a link, having a first end, operatively attached to the wheel carriage; wherein angles of the wheels and the width of the wheel carriage are sized to fit into multiple sizes of tracks.

Accordingly, various embodiments of the invention disclosed include: A method for attaching a disposable curtain system comprising: providing a track; preassembling a wheel system having: a wheel carriage, wheels attached to the wheel carriage; a link, having a first end releasably attached to the wheel carriage; and an extension releasably attached to a second end of the link; inserting an end connector into an extension or a quick release system, inserting the pre-assembled wheel system onto the track; and attaching the curtain using a curtain attachment to the quick-release system.

### BRIEF DESCRIPTION

Some of the embodiments will be described in detail, with reference to the following figures, wherein like designations denote like members, wherein:

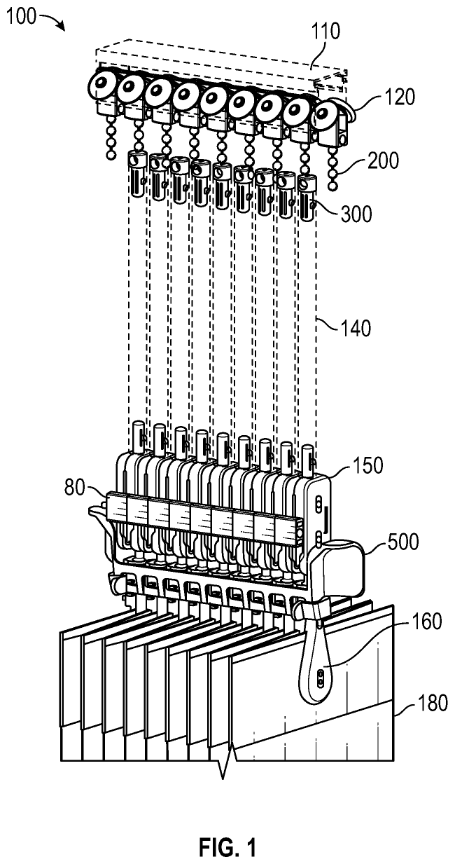

FIG. 1 shows a wheel system as part of a curtain hanging system according to an embodiment of the invention;

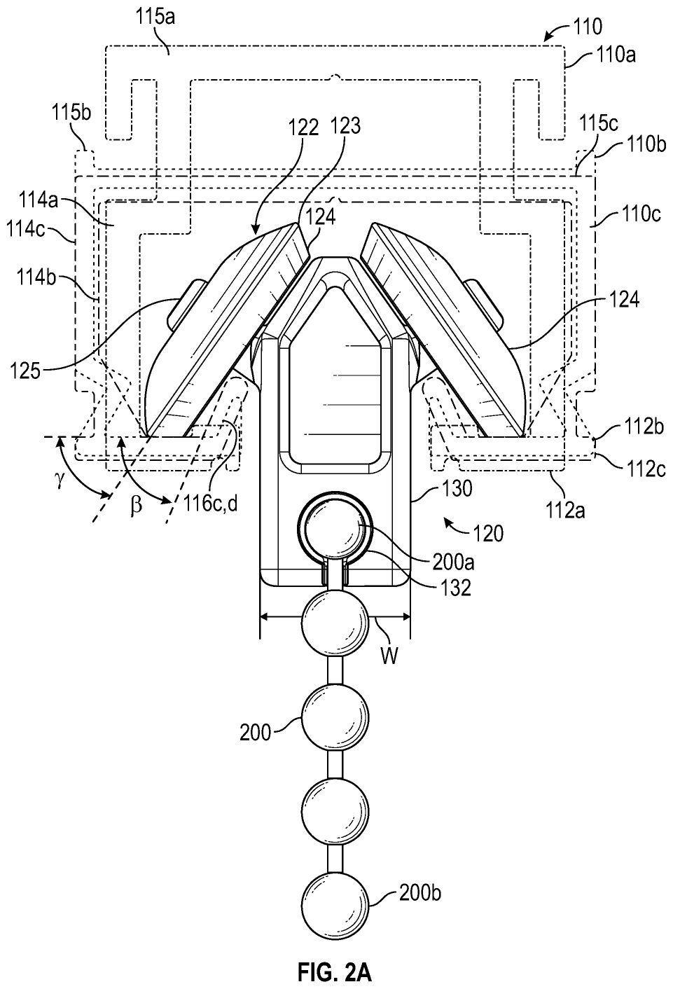

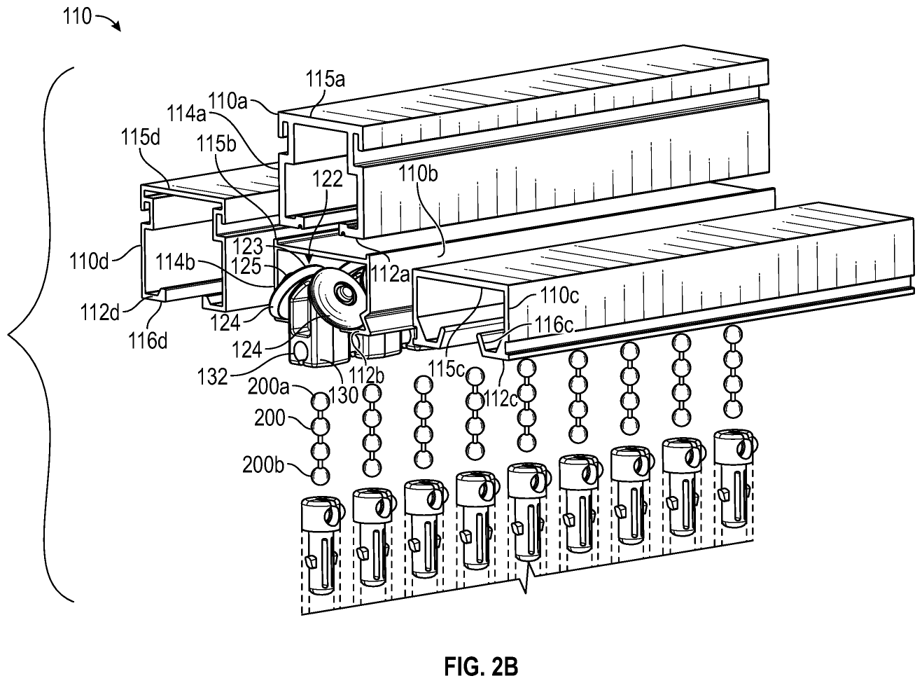

FIG. 2A shows a front view of dimensioning a wheel system according to a first embodiment of the invention having multiple tracks overlayed;

FIG. 2B shows a front view of dimensioning a wheel system according to a first embodiment of the invention having multiple tracks in an exploded view;

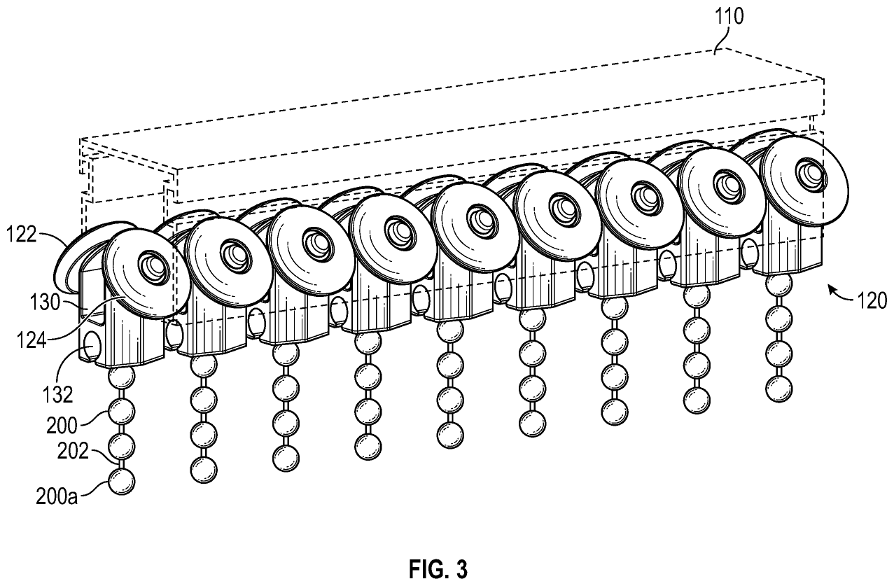

FIG. 3 shows a front and side perspective view of a wheel system according to a first embodiment of the invention;

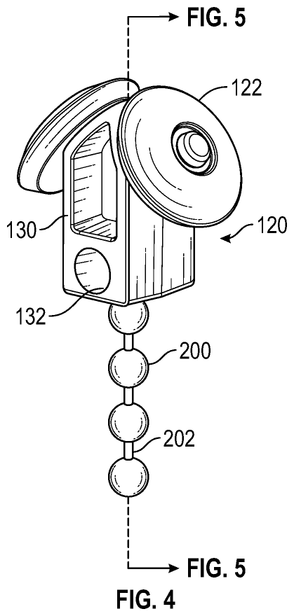

FIG. 4 shows a front and side perspective view of a wheel system (without end cap) according to a first embodiment of the invention;

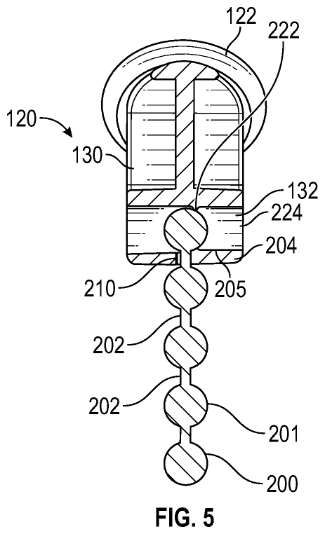

FIG. 5 shows a side perspective view of a wheel system through 5-5 according to a first embodiment of the invention;

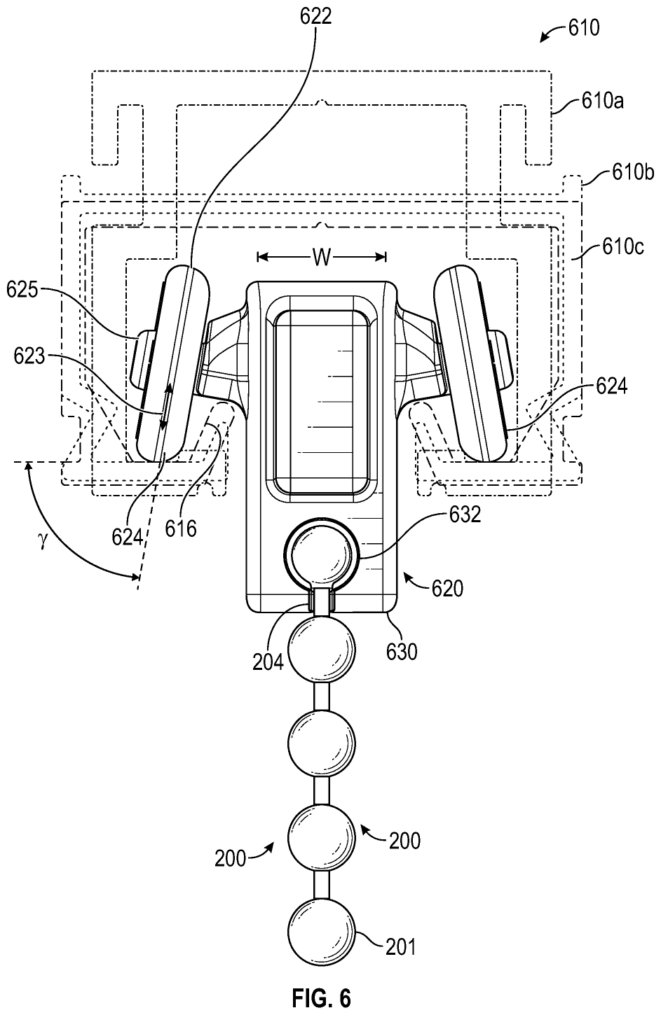

FIG. 6 shows a front view of dimensioning a wheel system (without end cap) in overlayed track systems according to a second embodiment of the invention;

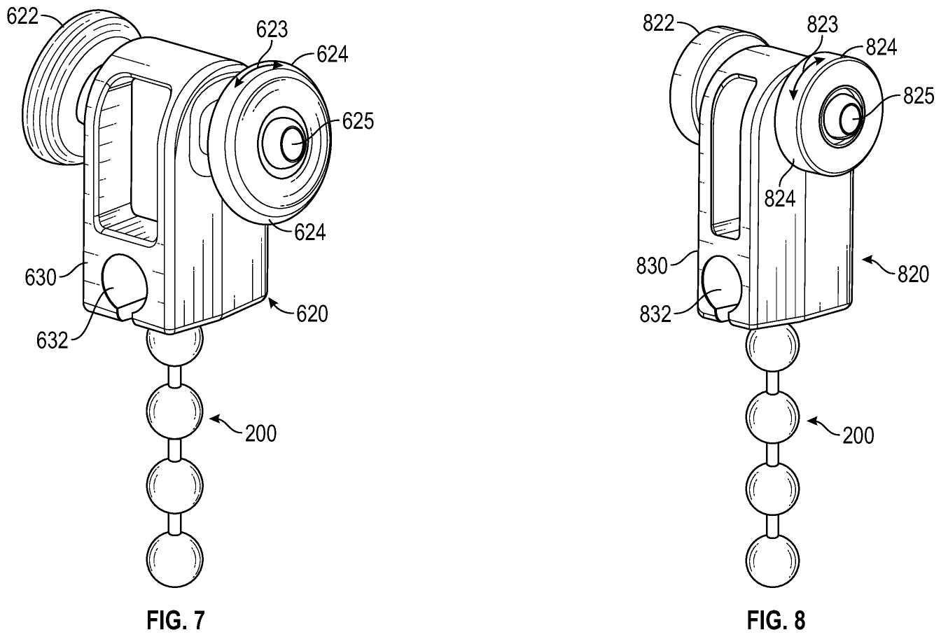

FIG. 7 shows a second embodiment of a perspective view of a wheel system according to a second embodiment of the invention;

FIG. 8 shows a perspective view of a wheel system (with end cap) according to third embodiment of the invention;

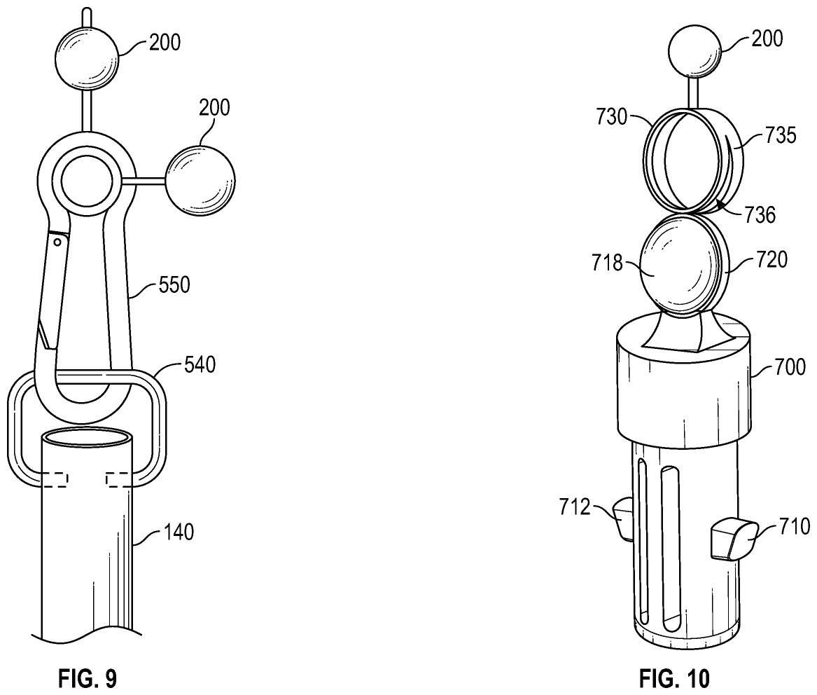

FIG. 9 shows an attachment without endcap according to an embodiment of the invention;

FIG. 10 shows a first embodiment of an end cap of an embodiment of the invention;

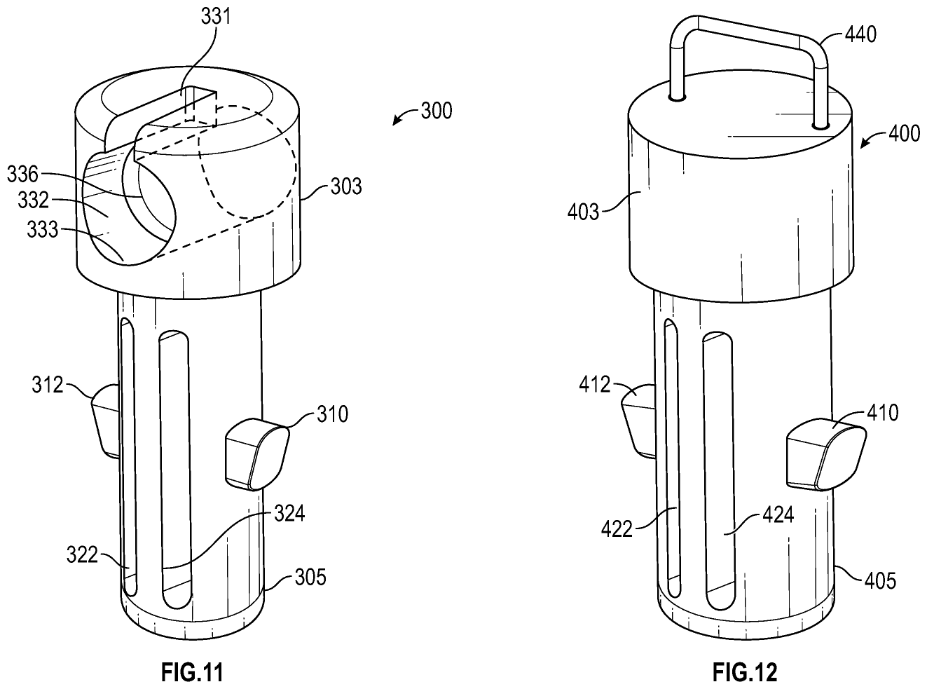

FIG. 11 shows a second embodiment of an end cap of an embodiment of the invention;

FIG. 12 shows a third embodiment of an end cap of an embodiment of the invention;

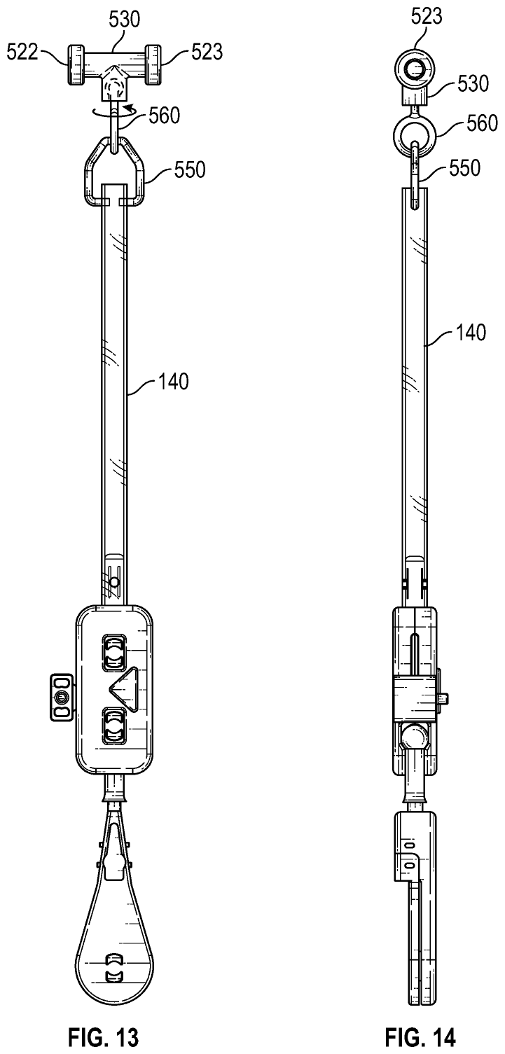

FIG. 13 shows a front side of an embodiment of an attachment of a wheel system;

FIG. 14 shows a side view of the embodiment of FIG. 13 of an attachment of a wheel system;

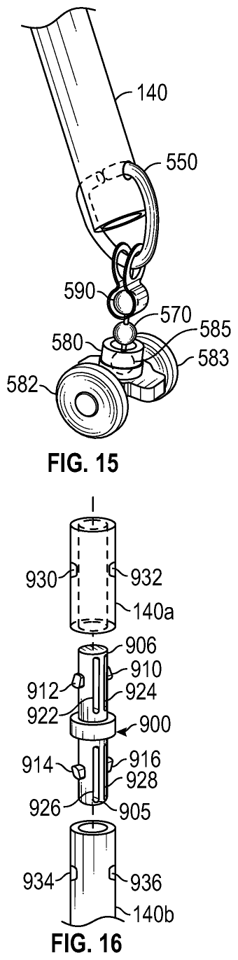

FIG. 15 shows another embodiment of an attachment of a wheel system; and

FIG. 16 shows an extension attachment for attaching two extensions together.

### DETAILED DESCRIPTION

Disclosed are various embodiments of the inventions. Referring to FIG. 1 is a disposable curtain system 100. The disposable curtain system 100 is attached to the ceiling by a track 110. The track may be attached directly to the ceiling or hang from the ceiling on extensions. Running through the track 110 are wheel systems 120. The roller hooks or rollers or wheels with attachments have a link 200 on the end thereof for attaching an extension or elongate member or extension 140. The link 200 may be any connector, ball chain, bead, retaining chain, clip, clasp, chain link, catch, snap, hook, safety pin, buckle metal loop, shackle, eyelet, grommet, carabiner, spring hook or any other attachment means or connector interposed between the wheel system an the end cap or extension or quick release and having a releasable attachment and adapted so that the extension or end cap or quick release does not come off the wheel system 120.

The extension 140 may be telescoping poles, poles that may be discreet sizes and interchanged depending on size needed, straps which may include a buckle that may be adjusted for size or the strap may be cut, a string, cable or wire that may be adjusted or cut. Since the extension will remain in place it is important that is easily cleanable for infectious diseases with an extension pole that has disinfectant. The material of the extension should not absorb liquids but should be made from a nonabsorbent plastic such as polyvinyl, acrylic, polyacrylic, nylon, carbon composite, PVC, polyethylene or the like.

The curtain 180 comes in discreet sections, such as 6-12 feet and most commonly 9 feet. The curtain discreet sections of 9-12 feet may be snapped together with snaps so as to make longer curtains. The curtains are made from disposable recyclable material such as polypropylene. Alternatively, the curtains may be made of cloth for quick change for washing. The curtains 180 may be attached to the extension 140 with a quick-release mechanism 150 and a curtain attachment assembly or curtain attachment 160. The curtain attachment has a locking mechanism 80. The curtain attachment 160 during shipping and the initial assembly may be held together with a zip-tie, twist tie 90 or a holder such as 500 shown in FIG. 1.

Referring to FIG. 2, a track(s) 110 are shown. The track(s) 110 is bolted, screwed, glued or otherwise attached to the ceiling. The track may also be on a hanging system and hang from the ceiling. The track 110 has an end piece (not shown) with snap connectors for the end piece. Running inside the track are roller hooks or rollers with wheel systems 120 having guide, rollers or wheels 122, 124. Additionally, other types of arrangements other than rollers or wheel systems 120 may be used so long as the slide easily along the track guides 118 such as slides, balls, or the like. Extending from the rollers or wheels are a link 200, i.e. a ball chain which is inserted for ease of replacement in an opening or bore 132.

The tracks 110 shown in FIG. 2 is actually a representation of a graphic drawing of four tracks overlain to arrive at a proper wheel angle and size and a wheel carriage 130 size. A first track 110a has a base track 112a, a side of track 114a and both sides and a top of track 115a. A second track 110b has a base track 112b, a side of track 114b and both sides and a top of track 115b. A third track 110c has a base track 112c, a side of track 114c and both sides and a top of track 115c. A fourth track 110d has a base track 112d, a side of track 114d and both sides and a top of track 115d. The tracks 110a-d are overlain and engineering calculations are made to obtain a width w of the wheel carriage 130. In addition, angle β, the angle between base of tracks 112a, 112b, 112c, 112d and track angle 116c,d is calculated. Each guide, roller or wheel has a circumference 123 and a wheel axle 125. In order so that the roller, guide or wheel 122 rotates smoothly in the track the inner contact surface 124 must be angled, inclined, rounded, flattened or tilted with respect to the base 112a-d so as to ride evenly on the base of all the base tracks 112a, 112b, 112c, 112d using angle γ, the angle between base of track 112a, 112b, 112c, 112d and circumference of guide, roller or wheel 123. In this case, the inner contact surface 124 is parallel or rides evenly upon the base of the track 112a-d. In FIG. 7, the inner contact surface 624 is rounded so as to ride evenly on the base. As shown, the angle γ must be such that the wheels 122 will not be hindered or rub on either the track angle 116c or 116d. If calculations are not made and accurately tested, an installer will need to carry multiple wheel systems depending upon the track used. This wheel system 120 only requires a single type or reduced number of wheels 122 to fit into one of four different tracks. Furthermore, wheel system 620 can fit into multiple tracks. Thus, using three wheel systems 120, 620 and 820 at least seven different tracks may be accommodated using only three wheels, whereas seven were needed in the past. The wheel system 120 is for use with a track 110, said wheel system 120 comprising: a wheel carriage 130, a set of wheels 122, 124 attached to the wheel carriage 130; a link 200, having a first end 200a, operatively attached to the wheel carriage 130 in slotted opening 132; wherein angles γ, β of the wheels and the width of the wheel carriage w are sized to fit into multiple sizes of tracks. The angles γ, β of the wheels and the width of the wheel carriage w are sized by overlaying multiple tracks in a design drawing and arriving at dimensions based upon overlaying multiple tracks.

FIG. 3 illustrates track 110 with multiple wheel systems 120 having wheels, guides or rollers 122, wheel carriages 130, links 200.

FIG. 4 shows a perspective view of a single wheel system 120. The links 200 may be balls 200a having lines or wires 202 therebetween. The link 200 may be any connector, ball chain, bead, retaining chain, clip, clasp, chain link, catch, snap, hook, safety pin, buckle metal loop, shackle, eyelet, grommet, carabiner, spring hook, wire loop, wire with attachments on the end such as beads or balls, or any other attachment means or connector interposed between the wheel system an the end cap or extension or quick release and having a releasable attachment and adapted so that the extension or end cap or quick release does not come off the wheel system 120.

Line 5-5 shows the cutaway of FIG. 5. FIG. 5 shows a cutaway of the wheel system 120 showing the guide roller or wheel 122, the wheel carriage 130, the link 200 or ball chain having balls 201 and line or wire 202. Within the slotted opening 132 is a slot 204, a back wall 210, a nib 205 and a cylindrical opening 224. The cylindrical opening is a connector for attaching another connector ball 200a therein. During use a ball 200a of the ball chain is placed into the opening 132 and slid along until it engages the nib 202. The cylindrical opening has a first diameter 224 and the nib 202 has a second diameter 222 so that the ball 202 must be press fitted over the nib to engage and be held in the center of the opening. The nib 202 is tapered so that during the press fit, the ball 200 may be slid over the nib 202 to be held in place.

FIGS. 6 and 7 shows an alternate embodiment which a track system 610. The track 610 shown in FIG. 6 is actually a representation of a graphic drawing of 3 tracks 610a, 610b, 610c overlain to arrive at a proper wheel angle and size and a wheel carriage 630 size. The tracks 610a-c are overlain and engineering calculations are made to obtain a width w of the wheel carriage 130. In addition, angle δ, the angle between base of tracks 610a, 610b and 610c and wheel circumference 622 is calculated. Each guide, roller or wheel has a circumference 623 and a wheel axle 625. In order so that the roller, guide or wheel 622, 624 rotates smoothly in the track the inner contact surface 124 must be angled to ride evenly on the base of all the base tracks 610a, 610b, 610c using angle δ, the angle between base of track 610a, 610b, 610c and circumference of guide, roller or wheel 123. If calculations are not made and accurately tested, an installer will need to carry multiple wheel systems depending upon the track used. This wheel system 620 only requires a single type of wheel 622 to fit into one of three different tracks.

FIG. 8 shows a third embodiment of a wheel system 820. In certain instances, a wheel is dimensioned so that it may not fit into any track. In this case the wheels 822 and 824 are small. The wheels 822 and 824 have a wheel axle 825. The wheels are positioned on a carriage 830 and have an opening 832 for receiving the link 200.

FIG. 9 shows a first type of link 200 attachment to an extension 140 or quick connect (not shown). The extension 140 has a wire loop that is attached thereto. The wire loop 540 is attached to the link 200 via a clasp or clip 550 through the wire loop 540. In this instance, a wheel system 120 is attached for use with a track 110, said wheel system comprising: a wheel carriage 130; a set of wheels 122, 124, attached to the wheel carriage 130; an extension connector 540 or wire loop is adapted to be attached to curtain hanging system such as the extension or quick connect. A link 200, having a first end, releasably attached to the wheel carriage 130 and a second end releasably attached to an extension 140 using clip or clasp 540.

FIG. 10 shows an alternate embodiment of the invention. In FIG. 10 is shown an end cap 700 having a solid circular plastic portion 718 molded therewith. The plastic portion 718 is solid and has a groove 720 therein for mating with corresponding springed circular openings 720, 735. A slot 736 is cut into the circular springed openings 720, 735 and will engage the groove 720. The circular springed openings are attached to the link 200.

FIG. 11 shows another embodiment of an end cap 300. This end cap 300 includes a cylindrical portion 305 for engagement with one of an extension 140 or a quick release system 150, said cylindrical portion 305 further including a catch 310, 312 for attachment to the extension 140; and a cap 303, extending from said cylindrical portion 305, said cap 303 having a connector 333 for attaching to a wheel carriage 130. The catch 310, 312 is a plurality of protrusions, wherein the plurality of protrusions are tapered along an axis of the cylinder 305, said plurality of protrusions 310, 312 adapted for engaging with openings within the extension. The cylindrical member 305 has a plurality of slots 322, 324 therein for allowing the plurality of extensions 310, 312 to flex and engage the openings within the extension. The cap 303 has a connector which includes a slotted opening 332 having a first diameter and a second diminished diameter at a nib 336 for engaging and releasably attaching a ball chain on a link 200.

Referring to FIG. 12, the connector of the cap 400 includes an eyelet or a handle 440 and has protrusions or catch 410, 412 and slots 422 and 424 on cylindrical body 405.

Referring to FIGS. 13 and 14, a wheel system is shown with a link or eyelet 560 and wire clip or clasp 550. The clip or clasp 550 attaches to an extension 140. Holes are drilled into the extension 140. The portion of the eyelet 560 that attaches to the wheel carriage 530 having wheels 522 and 523.

FIG. 15 shows an alternate wheel system. The wheel carriage 580 includes wheels 582 and 583. The wheel carriage 580 is attached to a ball chain 570. One of the balls 585 on one side is encased within the wheel carriage 580. The opposite side ball is attached to a ball clip 590 which is attached to a wire clip or clasp 550 which is attached to an extension 140.

FIG. 16 shows an extension connector 900. The connector assists in connecting extensions 140a and 140b. The extensions 140a and 140b have holes 930, 932 and 934, 936 which engage with catches 910, 912, 914 and 916. The catches 910, 912, 914 and 916 are tapered so as to allow the catches to slide into the holes 930, 932, 934 and 936 when the ends 905 and 906 are inserted into the rods or extensions 140a, 140b. The connector has material removed at 922, 924, 926 and 928 to allow the connector to flex. The advantage of the extension connector 900 is so that the length of the entire extension may be changed by adding or decreasing extensions 140a, 140b. For example if an installer enters into a facility for installation with 24 inch rods or extensions 140a, 140b and discovers a room that needs 36 inch rods rods or extensions. The installer may add 12 inches to the 24 inch rods or extensions to arrive at 36 inch rods or extensions.

A method for attaching a disposable curtain system is also disclosed. The method is performed by providing a track 110. Next is the step of preassembling a wheel system 120 having a wheel carriage 130, wheels 122, 124 are attached to the wheel carriage 130. A link 200, having a first end 200a releasably attached to the wheel carriage 130e; and an extension 140 releasably attached to a second end of the link 200b. The step of inserting an end connector such as an end cap 300, 400 or a clip or clasp 550 with wire loop 540 into an extension 140 or a quick release system 150. The wheel system 130 is inserted onto the track; and attaching the curtain 180 using a curtain attachment 160 to the quick-release system 150.

In the method, the extension 140 has a first end attached to an end cap 300, 400, 700 and a second end attached to the quick release system 150.

The method further comprising: providing an end cap 300, 400, 700 with a cylindrical portion 305, 405 for engagement with the extension 140 or quick release 150, said cylindrical portion 305, 405 further including a catch 310, 312 or 310, 412 for attachment to the extension 140; and a cap 303, extending from said cylindrical portion 305, said cap 303 having a connector 332 for attaching to a wheel carriage 130; and the step of inserting the end cap 300, 400 further comprises inserting the cylindrical end 305, 405 into an extension 140 or a quick release system.

The end caps 300, 400, 700 and wheels systems are all made using injection molded parts using materials such as thermoplastic or thermosetting polymers, elastomers or metals. Common polymers like epoxy and phenolic are examples of thermosetting plastics which nylon, polyethylene and polystyrene are thermoplastic or acetyl plastics.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

What is claimed is:

1. A wheel system, for use with a track, said wheel system comprising:
a wheel carriage;
a set of wheels, attached to the wheel carriage;
a link, having a first end, releasably attached to the wheel carriage and a second end releasably attached to an extension.

2. The wheel system of claim 1, wherein the link is attached to one of an extension connector or an end cap connector attached to a top end of the extension.

3. The wheel system of claim 10, wherein the link is one of a ball chain, clip, clasp, chain link, catch, snap, hook, safety pin, buckle metal loop, shackle, eyelet, grommet, carabiner or spring hook.

4. The curtain system of claim 1 wherein the extension is a hollow rod made of one of nylon, acrylic or other polymer.

5. A kit, wherein the kit includes a wheel system as claimed in claim 1 and further comprising at least two sets of wheel systems.

6. The kit of claim 5, wherein the wheel systems have wheels with axes at different angles with respect to each other.

7. The kit of claim 5, wherein the wheel systems have wheels of different sizes.

8. The kit of claim 5, wherein the wheel systems are interchangeable.

9. The kit of claim 5, wherein the wheel systems have different sized wheel carriages.

10. A wheel system, for use with a track, said wheel system comprising:
a wheel carriage;
a set of wheels, attached to the wheel carriage;
a link, having a first end, operatively attached to the wheel carriage;
wherein angles of the wheels and the width of the wheel carriage are sized to fit into multiple sizes of tracks.

11. The wheel system of claim 10, wherein the angles of the wheels and the width of the wheel carriage are sized by overlaying multiple tracks in a design drawing and arriving at dimensions based upon overlaying multiple tracks.

12. A method for attaching a disposable curtain system comprising:
providing a track;
preassembling a wheel system having:
a wheel carriage,
wheels attached to the wheel carriage;
a link, having a first end releasably attached to the wheel carriage; and
an extension releasably attached to a second end of the link;
inserting an end connector into an extension or a quick release system,
inserting the pre-assembled wheel system onto the track; and
attaching the curtain using a curtain attachment to the quick-release system.

13. The method of claim 12, for attaching a disposable curtain system comprising:
wherein the extension has a first end attached to an end cap and a second end attached to the quick release system.

14. The method of claim 12, for attaching a disposable curtain system further comprising:
providing an end cap with a cylindrical portion for engagement with the extension or quick release, said cylindrical portion further including a catch for attachment to the extension; and
a cap, extending from said cylindrical portion, said cap having a connector for attaching to a wheel carriage; and
the step of inserting the end cap further comprises inserting the cylindrical end into an extension or a quick release system.
